(19) United States
(12) Patent Application Publication
(10) Pub. No.: US 2026/0346649 A1
(43) Pub. Date: Nov. 5, 2026

(54) WINTER TYRE

(71) Applicant: PIRELLI TYRE S.P.A., Milano (IT)

(72) Inventors: Giovanni CASAROTTO, Milan (IT); Stefano MONTESELLO, Milan (IT); Diego Ettore SPEZIARI, Milan (IT)

(73) Assignee: PIRELLI TYRE S.P.A., Milano (IT)

(21) Appl. No.: 19/485,856

(22) PCT Filed: May 13, 2024
(86) PCT No.: PCT/IB2024/054635

§ 371 Date: Nov. 19, 2025

(30) Foreign Application Priority Data
May 31, 2023 (IT) 102023000011049

(51) Int. Cl. B60C 11/03; B60C 11/12

(52) U.S. Cl. CPC B60C 11/0302; B60C 11/1218

(57) ABSTRACT

A Tyre (1 includes a tread band (2) on which a plurality of blocks (8) are defined, extending transversely from a first zone (N 1) to a second zone (N2), at least one sipe (10) having a siping width (W). The sipe (10) separates the block (8) into a first portion (11) comprising a first surface (13), as well as a second portion (12) comprising a second surface (14). In a third zone (N3) located between the first zone (N1) and the second zone (N2), at least one of the first surface (13) and the second surface (14) moves away from a respective reference plane (X, X') up to the tread surface (3), creating at least one chamfer (30). The chamfer (30) has, in correspondence with the tread surface (3), a chamfer width (W1) of a size greater than the siping width (W).

The present invention relates to a tyre, especially a winter tyre.

### FIELD OF THE INVENTION

More specifically, the invention relates to a winter tyre with improved performance, particularly on snowy road surfaces. The tyre, which is the object of the present invention, allows, in any case, due to its structure, to guarantee optimal performance also in other conditions/surfaces such as dry or wet ground.

### STATE OF THE ART

A tyre generally comprises a carcass structure, toroidally shaped around an axis of rotation, on which are applied, in a radially outer position, a belt structure and, in further superposition, a tread band, made of elastomeric material, on which is defined a tread surface intended for contact with the road surface.

On the tread band, a plurality of circumferential and/or transverse grooves is typically defined, delimiting a corresponding plurality of blocks which, as a whole, define the tyre's tread pattern.

The characteristics of the tread band, and in particular the quantity and configuration of the grooves and blocks provided on the tread surface, mainly determine the tyre's performance in terms of road behavior, especially regarding the possible different conditions of the road surface itself.

To improve the grip of a tyre on snowy ground, small cuts, also known as “sipes”, can be made on the blocks of the tread band, extending from the tyre's tread surface towards the inside of the block. The function of these cuts is to offer additional gripping elements on the snowy surface and to retain a certain amount of snow, thereby improving the adherence with the snowy road surface.

However, the presence of cuts on the blocks of the tread band can reduce the performance of the tyre in case the road surface is free of snow, whether it is dry or wet, due to the decreased ability of the blocks to adequately resist cutting stresses in acceleration, braking or cornering.

A tyre is defined as “directional” when it is configured to have a preferential rolling direction, typically coinciding with the direction of rotation of the tyre when mounted on a vehicle moving forward.

On the tread surface of a directional tyre, a “direction of advancement” is identified, tangential to the tread surface and directed in the preferential rolling direction of the tyre.

A tyre is defined as “asymmetric” when it is configured to have a design on one side of the tread different from that on the opposite side.

The term “equatorial plane” of the tyre indicates a plane perpendicular to the axis of rotation of the tyre.

The terms “radial” and “axial” and the expressions “radially inner/outer” and “axially inner/outer” are used with reference to the axis of rotation of the tyre, while the terms “circumferential” and “circumferentially” are used with reference to the direction of the annular development of the tyre, that is, to the rolling direction of the tyre, which corresponds to a direction lying on a plane coincident with or parallel to the equatorial plane of the tyre.

In particular:

The term “radial direction” is used to indicate a direction substantially perpendicular to the axis of rotation of the tyre.

With the term “axial direction” or “transverse direction”, it is intended to indicate a direction parallel to the axis of rotation of the tyre, or inclined with respect to this axis by an angle less than or equal to 45°.

The term “circumferential direction” or “longitudinal direction” is used to indicate a direction parallel to the rolling direction of the tyre, or inclined with respect to the rolling direction by an angle less than 45°.

With the term “effective width” referred to the tread band, it means the width of the radially outermost portion of the tread band (from edge to edge) intended for contact with the ground.

With “central zone” of the tread band, it means a region of the tread surface centered on the equatorial plane of the tyre and extended for a measure up to 60% of the effective width of the tread band.

With “shoulder zone”, the regions of the tread surface extended from the axially opposed ends of the tread band to the central region are identified in a symmetrical way with respect to the equatorial plane of the tyre.

With the term “groove”, it means a recess made on the tread surface, having at least one portion having a width of at least 1.5 mm. Preferably, this groove has a minimum depth of about 5 mm.

With the term “sipe”, it means instead a recess made in a portion of tread band, having a width between about 0.1 mm and 1.5 mm.

Each sipe separates the block on which it is made into two portions of block having respective surfaces facing each other.

These surfaces are extended at least partially along a respective “reference plane” incident to the tread surface and coinciding with the respective surface net of any protrusions and recesses.

A sipe is of the “three-dimensional type” when at least one of the surfaces facing each other of the block portions comprises at least one protrusion and/or at least one recess that deviates from the respective reference plane by a variable distance along the depth of the sipe. In the case where a recess is located in correspondence with and able to accommodate at least in part a protrusion, the three-dimensional type sipe forms a male-female coupling. In this way, a relative displacement of the two block portions along a direction parallel to the reference plane is hindered by the interference between the two block portions in correspondence with the protrusion and the recess.

A sipe is defined of the “simple type” when on the surfaces facing each other of the block portions there are no protrusions and/or recesses and/or there are protrusions or recesses that deviate from the reference plane by a constant distance along the depth of the sipe.

In this way, the surfaces reciprocally facing of the block portions do not interfere with each other in case of a relative displacement along a direction parallel to the reference plane.

With the term “chamfer”, it is meant that the transition portion that is created between a radially extended block surface made by the sipe and the tread surface portion located at the block, forms a surface instead of an edge. For example, the transition portion can be an inclined surface. In other words, the edge that would structurally be created due to the presence of the sipe, as a transition portion between the radially extended block surface and the block surface located on the tread, is eliminated/chamfered and replaced by a surface. In this way, the radially extended block surface moves away from its reference plane up to the tread surface portion at the block, forming the chamfer.

With reference to a sipe or a portion of it, the terms “widen” or “widening” and “narrow” or “narrowing” are generally used with reference to a cross-section of the sipe. Therefore, a widening of the sipe involves an increase in the cross-section and therefore the width of the sipe, while a narrowing of the sipe involves a reduction in the cross-section and therefore the width of the sipe. Unless otherwise indicated, the “width” of a sipe (or more generally of a recess) is intended to be estimated at the tread surface, on a new tyre.

With “substantially flat” connecting surface, it indicates a surface that is flat for at least 50% of its extension. With “apex” of a protrusion or a recess, it means the point or points of the protrusion or the recess having the greatest distance from the respective reference plane.

An example of a winter tyre whose blocks are affected by three-dimensional type sipes is described in the international patent application WO2017212399, in the name of the same Applicant. Furthermore, an example of a tyre whose blocks have a chamfer is described in the international patent application WO2018122713, in the name of the same Applicant.

### SUMMARY OF THE INVENTION

The Applicant has primarily found that the prediction of three-dimensional type sipes on the blocks increases their stiffness, compared to when the blocks have only simple type sipes, when these blocks are subjected to shear stresses, improving the tyre's performance on both dry and wet surfaces during braking, traction, and cornering.

In particular, the Applicant observed that the stiffness of a block increases with the interference between the block portions, and therefore with the increase in size and number of protrusions on their respective surfaces.

However, at the same time, the Applicant has verified that such an increase in block stiffness, due to the provision of three-dimensional type sipes, may correspond to less mutual mobility of the adjacent block portions, resulting in less effectiveness in retaining snow and therefore performance on snowy surfaces, due to the tyre-snow friction, which is notoriously very low and is the main cause of tyre slipping and consequently, the slipping of the entire vehicle. In this context, the Applicant felt the need to design a tread pattern capable of improving the tyre's performance on snowy surfaces as well as overall on dry or wet surfaces, while maintaining its safety level.

In this context, the Applicant felt the need to design a tread pattern capable of improving the tyre's performance on snowy surfaces as well as overall on dry or wet surfaces, while maintaining its safety level. The Applicant perceived that this goal can be achieved by creating sipes extended transversely between the ends of the blocks, including at least one chamfer in a position spaced from the ends of the blocks.

The Applicant understood that this goal can be achieved by creating sipes extended transversely between the ends of the blocks, including at least one chamfer in a position spaced from the ends of the blocks.

In particular, the aforementioned sipe extends between a first zone, located at a first end of the block, and a second zone, located at a second end of the block; the aforementioned chamfer is obtained on the sipe in a third zone, located between the first and second zone.

In more detail, the chamfer has a greater width than the width of the sipe in the first and second zone.

In this way, the Applicant believes that a substantially “pocket” shape/structure is created between the facing surfaces of the blocks, in which the chamfer forms the central part of the “pocket” itself, while the end portions of the sipe, located on the sides of the chamfer and having a smaller width than that of the chamfer, outline the ends of the pocket.

This structure generates, according to the Applicant, an invitation for the snow that, during the rolling of the tyre, inserts itself inside the “pocket”, getting stuck.

In particular, during rolling, and therefore when a portion of the tyre enters the footprint area, i.e. in contact with the ground, the chamfer, acting as a “pocket”, opens more than the ends of the sipe, favoring the entry of snow inside the sipe, to then close when the portion of tyre exits the footprint area, retaining the snow inside. The rolling not only causes the snow to adhere to the tyre but also that the pressure of the snow itself, rotation after rotation, increases the amount of snow trapped in the “pockets” formed by the sipes, as well as the effect of interlocking the same inside the sipe.

Providing that the aforementioned chamfer is substantially present in a distributed manner on the sipes of the tyre, the Applicant has verified that several portions of tyre are created, arranged substantially homogeneously along the rolling direction, in which a greater amount of snow gets stuck.

In particular, in its first aspect, the invention relates to a tyre comprising a tread band on which a tread surface is defined in a radially outer position to said tyre. Preferably, the aforementioned tread band comprises a plurality of grooves and a plurality of treads delimited by at least a first pair of grooves of said plurality of grooves. Preferably, the grooves of said first pair of grooves are mostly arranged in the longitudinal direction on the tread.

Advantageously, said first pair of grooves defines on said tread a first tread edge and a second tread edge. In further preferred, but not limiting, embodiments, the direction in which said first pair of grooves is arranged on said tread defines an angle with respect to the equatorial plane.

In other preferred embodiments, said plurality of treads is also delimited by a second pair of grooves of said plurality of grooves. Preferably, the grooves of said second pair of grooves are typically arranged in the transverse direction on said tread.

Generally, preferably, said tread band comprises a plurality of sipes extended transversely on the plurality of treads.

Preferably, this plurality of sipes is substantially parallel to the respective second pair of grooves of said plurality of grooves.

In more detail, advantageously, generally, each sipe of the plurality of sipes extends from a first zone of said tread, preferably located at said first edge, to a second zone of said tread, preferably located at said second edge.

This plurality of sipes is preferably open on said tread band.

Preferably, the plurality of sipes has a sipe width. Each sipe of said plurality, preferably, has said sipe width both in said first zone and in said second zone of tread.

Preferably, each sipe separates said at least one tread into a first tread portion comprising a first surface and a second tread portion comprising a second surface.

Said first surface is preferably extended along a first reference plane incident to the tread surface. Preferably, said second surface is extended along a second reference plane incident to said tread surface. Preferably, the second surface faces the first surface.

In a further preferred embodiment, said tread comprises at least a first sipe and a second sipe, as described above, substantially parallel to each other.

In this case, preferably, the first and second sipe are longitudinally spaced from each other by a distance greater than or equal to 3 mm.

Preferably, the first and second sipe are longitudinally spaced from each other by a distance less than or equal to 6 mm.

Even more preferably, the first and second sipe are longitudinally spaced from each other by a distance between 3 mm and 6 mm, extremes included. More preferably, the first and second sipe are longitudinally spaced from each other by a distance between 3.2 mm and 4.6 mm.

Even more preferably, the sipes placed parallel to each other are in number of three.

Preferably, in a third zone of the tread located between said first zone and said second zone of said tread, at least one of said first surface and said second surface moves away from the respective reference plane up to said tread surface creating a chamfer.

Preferably, said chamfer has, in correspondence with said tread surface, a chamfer width of a size greater than said sipe width.

Preferably, said chamfer is formed in correspondence with treads defined in axially opposed shoulder zones of said tyre.

Preferably, said chamfer is formed in correspondence with treads defined in axially opposed intermediate zones of said tyre where, said intermediate zones are included, preferably, between a central zone of said tyre and said shoulder zones.

Even more preferably, said chamfer is formed in correspondence with treads defined in the central zone of said tyre, which is included between the aforementioned axially opposed shoulder zones.

Alternatively, on said central zone of said tread band, preferably, treads equipped only with simple type sipes are provided.

Furthermore, in preferred but not limiting embodiments, the chamfer width is greater than the sipe width by a quantity greater than or equal to 30% of the sipe width.

Preferably, the chamfer width is greater than the sipe width by a quantity less than or equal to 150% of the sipe width.

In preferred forms, the chamfer width is greater than the sipe width by a quantity greater than 30% and less than 150% of the sipe width, extremes included.

Preferably the chamfer width is double the sipe width.

Advantageously, in this way, the “pocket” shape/structure is generated for the invitation and interlocking of the snow during the rolling of the tyre, between the chamfer which, as previously said, forms the central part of the “pocket” and the portions of sipe placed at its sides that go to form the ends of the pocket.

In a first preferred variant, in correspondence with the chamfer, both the first surface and the second surface of the tread, are both inclined from opposite sides with respect to the respective reference plane of a respective first angle and a respective second angle.

In a second alternative variant, in correspondence with the chamfer, only the first surface or the second surface is inclined from opposite sides with respect to the respective reference plane of a respective first angle, in the case where the first surface is inclined or of a respective second angle, in the case where the second surface is inclined.

Preferably, in both variants, where provided, said second angle is greater than said first angle.

Preferably, said first angle and/or said second angle are/is greater than or equal to about 5°. Preferably, said first angle and/or said second angle are/is less than or equal to about 50°.

Even more preferably, said first angle and/or said second angle are greater than about 5°and less than about 50°, extremes included.

More preferably, said first angle and/or said second angle are greater than or equal to about 10°.

Preferably, said first angle and/or said second angle are less than or equal to about 15°.

Preferably, said first angle and/or said second angle are greater than about 10° and less than about 15°, extremes included.

Preferably, the chamfer has a radial dimension that goes from a top portion of said sipe to said tread surface.

Preferably, the aforementioned top portion is located in a radially external position with respect to a base of said sipe.

Even more preferably, said base of the sipe and said top portion each lie on their respective reference plane.

Even more preferably, said reference plane on which said base and said top portion lie is the same.

Preferably, the radial dimension of the chamfer is greater than or equal to 1 mm.

Even more preferably, the radial dimension of the chamfer is less than or equal to 2 mm.

In preferred embodiments, the radial dimension of the chamfer is greater than 1 mm and less than 2 mm, extremes included.

Furthermore, in preferred but not limiting embodiments, said chamfer has an extension on said tread, in the transverse direction, greater than or equal to 35% of the lateral extension of said tread.

With lateral extension of the tread is meant the length of one side of such tread in the transverse direction as defined above.

Preferably, said chamfer has an extension on said tread, in the transverse direction, less than or equal to 95% of the lateral extension of said tread.

Even more preferably, said chamfer has an extension on said tread, in the transverse direction greater than 35% and less than 95% of the lateral extension of said tread, extremes included.

Advantageously, this allows the creation of the “pocket” structure as previously defined.

Furthermore, in another embodiment, said tread includes a fourth zone. This fourth zone is located between said first zone and said second zone of said tread.

Preferably, in this fourth zone of the tread, said sipe has the aforementioned sipe width.

Always preferably, in the embodiment under examination, at least one of said first surface and said second surface moves away from the respective reference plane up to said tread surface, creating a first chamfer and a second chamfer.

Advantageously, said first chamfer and said second chamfer are arranged in two respective third zones separated from each other by said fourth zone, and have said chamfer width in correspondence with the tread surface.

Even more preferably, said tread includes said fourth zone when said lateral extension of said tread is greater than or equal to 30 mm.

Preferably, said tread includes said fourth zone when said lateral extension of said tread is less than or equal to 60 mm.

Even more preferably, said tread includes said fourth zone when said lateral extension of said tread is greater than 30 mm and less than 60 mm, extremes included.

Dually, preferably, when the length of said chamfer is greater than 20 mm in the intermediate zone and/or greater than 26 mm in the shoulder zone, said sipe includes said first chamfer and said second chamfer.

Preferably, said first chamfer and said second chamfer have an extension greater than or equal to 35% of the lateral extension of the tread.

Preferably, said first chamfer and said second chamfer have an extension less than or equal to 60% of the lateral extension of the tread.

Preferably, said first chamfer and said second chamfer have an extension greater than 35% and less than 60%, extremes included, of the lateral extension of the tread.

Even more preferably, said first chamfer and said second chamfer have, respectively, an extension of 40% of the lateral extension of the tread.

More preferably, the sum of the extension of said first chamfer and said second chamfer is less than 95% of the lateral extension of said tread.

Advantageously, this fourth zone is designed to keep high the amount of snow that can be trapped inside the sipe, avoiding very extensive chamfers. In a further preferred embodiment, this plurality of sipes is of the three-dimensional type.

These three-dimensional type sipes obtained on said at least one tread are extended on the tread surface along substantially parallel directions and divide said at least one tread into portions having a substantially equal circumferential size to each other.

In this way, each tread has mechanical characteristics (in particular resistance to shear stresses) that are substantially homogeneous in correspondence with the different portions into which it is divided by the three-dimensional type sipes.

Preferably, between said first portion of tread and said second portion of tread, a plurality of male-female couplings is provided.

Preferably, all the male-female couplings between said first portion of tread and said second portion of tread are formed by at least one protrusion formed on said first surface and extended from said reference plane towards said second portion of tread, and by at least one recess formed on said second surface and extended from said reference plane away from said first portion of tread.

Preferably, this protrusion is located, in a portion of maximum protrusion, at a radially internal level with respect to said tread surface. Preferably, this level is not higher than 45% of the depth of said sipe.

Even more preferably, this level is 40% of the depth of the sipe. Preferably, this level is greater than 2 mm and less than 3 mm.

The above-mentioned characteristics, alone or in combination with each other, define a conformation of the protrusions that advantageously allows not to excessively weaken the portion of the tread on which the recesses are obtained, despite the protrusions being positioned near the tread surface.

Furthermore, this conformation of the protrusions allows the tyre to be more easily extracted from the vulcanization mold.

In preferred but not limiting embodiments, said at least one protrusion includes, in the portion of maximum protrusion, a respective edge that extends substantially parallel to said first reference plane.

Preferably, said edge is radially positioned between said base and said top portion of said sipe.

Advantageously, the position of the edge and its extension, structurally, make the aforementioned “pocket” effect more effective, favoring the interlocking of the snow inside the sipe.

The present invention, in the aforementioned aspect, can present at least one of the preferred characteristics indicated below, considered individually or in combination with each other.

According to a preferred embodiment, said at least one protrusion has a substantially prismatic conformation with a quadrilateral plan.

Preferably, in the aforementioned embodiment, said edge is connected to said first reference plane through substantially flat lateral and radial connection surfaces. Preferably, said radial connection surfaces are arranged radially above and below said edge.

Preferably, said lateral connection surfaces are located in correspondence with two opposite sides of said edge.

Preferably, said lateral connection surfaces are located in correspondence with two opposite sides of said edge.

In preferred but not limiting embodiments, said lateral connection surfaces are inclined, respectively, from said edge to said first reference plane, by a third and a fourth angle with respect to a third plane perpendicular to said first reference plane.

Preferably, said third and fourth angles are substantially equal.

In more detail, preferably, said third angle and/or said fourth angle are less than 55°.

Preferably, said third angle and/or said fourth angle are greater than 35°.

More preferably, said third angle and/or said fourth angle are between 35°and 55°, extremes included.

For example, said third angle and/or said fourth angle are 45°. Preferably, said radial connection surfaces are inclined radially above from said edge to said first reference plane by a fifth angle and radially below from said edge to said reference plane by a sixth angle.

Advantageously, preferably said sixth angle is less than said fifth angle.

In more detail, preferably, said fifth angle is less than 50°. Preferably, said fifth angle is greater than 40°.

More preferably, said fifth angle is between 40°and 50°, extremes included. For example, said fifth angle is 45°.

Advantageously, the amplitude of said fifth angle depends on the depth of said sipe. Regarding said sixth angle, preferably it is less than 35°.

Preferably, said sixth angle is greater than 10°. More preferably, said sixth angle is between 10°and 35°, extremes included.

For example, said sixth angle is 16°.

Advantageously, the amplitude of said sixth angle depends on the depth of said sipe.

In more detail, the greater the depth of the sipe, the greater the amplitude of said sixth angle, as seen in the following examples. Just as an example, when said sipe has a depth of 5 mm, said sixth angle is preferably 10°. Again as an example, when said sipe has a depth of 7 mm, said sixth angle is preferably 16°.

Another example is that when said sipe has a depth of 9 mm, said sixth angle is preferably 35°.

Preferably, a first radial connection surface connects to said first reference plane radially below with respect to said edge at a respective level radially above with respect to said base of said sipe.

A second radial connection surface connects, preferably, to said first reference plane radially above with respect to said edge at a respective level radially below with respect to said at least one chamfer.

Preferably, the lateral connection surfaces of two edges of protrusions adjacent to each other realize a connected portion, lying on said reference plane and having an extension in direction parallel to said reference plane less than the extension of at least one of said two edges.

Preferably, the extension of said edge is greater than or equal to 2 mm. Always preferably, the extension of said edge is less than or equal to 5 mm.

In preferred forms, the extension of said edge is greater than 2 mm and less than 5 mm, extremes included.

Furthermore, preferably the extension of said connected portion is greater than or equal to 0.5 mm. Preferably, the extension of said connected portion is less than or equal to 3 mm.

In preferred forms, the extension of said connected portion is greater than 0.5 mm and less than 3 mm, extremes included.

In preferred but not limiting embodiments, said tyre is of the directional type when said first surface does not include recesses and said second surface does not include protrusions. In further preferred but not limiting embodiments said tyre is of the asymmetric type.

In particular, preferably, the tyre is of the asymmetric type in the case where the sipe is not of the three-dimensional type or, alternatively, in the case where also said first surface includes recesses and said second surface includes protrusions.

### BRIEF DESCRIPTION OF THE DRAWINGS

The characteristics and advantages of the invention will be better understood from the detailed description of a preferred embodiment, illustrated for indicative and non-limiting purposes, with reference to the attached drawings, wherein:

FIG. 1A shows a plan view of a portion of the tyre tread band according to the present invention;

FIG. 1B presents an enlarged-scale view of a zone within the tread band portion of FIG. 1A, indicated as II, including a block with a sipe, in accordance with one embodiment of the present invention;

FIG. 1C depicts an enlarged-scale view of another zone within the tread band portion of FIG. 1A, indicated as III, including a block with a sipe comprising both a first and a second chamfer, according to another embodiment of the present invention;

FIG. 2A is a longitudinally sectional view, at various depths and on an enlarged scale, of a sipe within a block, in accordance with a specific embodiment of the present invention;

FIG. 2B is an enlarged-scale detailed view of one of the visible portions in the section of FIG. 2A;

FIG. 2C is an enlarged-scale cross-sectional view along line A-A of the sipe in FIG. 2A;

FIG. 2D is an enlarged-scale cross-sectional view along line B-B of the sipe in FIG. 2A.

FIG. 2E is an enlarged-scale cross-sectional view along line C-C of the block in FIG. 2A;

FIG. 3A is a front perspective view of the block from FIG. 2A;

FIG. 3B provides a rear perspective view of the block from FIG. 2A;

FIG. 3C shows a frontal view of the block from FIG. 2A.

### DETAILED DESCRIPTION

Referring to the enclosed figures, with 1 is generally indicated a tyre realized according to the present invention. The tyre 1 includes a tyre structure, conventionally represented but not shown in the attached figures, as well as a tread band 2 positioned radially outward from the tyre 1 and defining a tread surface 3.

The portion of the tread band 2 specifically designed to come into contact with the road surface extends axially to define an effective width L and is radially connected at its axially opposite ends to the tyre's sidewalls 4. Within the effective width L of the tread band, a central zone C of the tread band 2 is identified, symmetrically extending around an equatorial plane P of the tyre. Two intermediate zones 5, adjacent to the central zone C and axially symmetrically arranged with respect to it, as well as two shoulder zones 6, respectively adjacent to the two intermediate zones 5 and axially symmetrically positioned relative to the same two intermediate zones 5, are also identified.

A plurality of grooves, denoted by reference numerals 7A and 7B, are formed on the tread band 2. Advantageously, this plurality of grooves includes at least a first pair of grooves 7A. Preferably, the aforementioned first pair of grooves 7A is predominantly oriented substantially longitudinally on the tyre 1. In additional preferred but not limited embodiments, the direction in which at least one groove of the first pair of grooves 7A is oriented on the tread block defines an angle relative to the tyre's equatorial plane P.

Advantageously, the angle between the equatorial plane and at least one of the first pair of grooves 7A is greater than 10°and less than 45°.

In more detail, in a first embodiment of the tyre 1 according to the present invention, the aforementioned first pair of grooves 7A defines a plurality of blocks 8 arranged successively along a circumferential development of the tread band 2. Advantageously, this first pair of grooves 7A defines, on each block 8, a first edge 80 and a second edge 81.

In other preferred embodiments, this plurality of blocks 8 is also delimited by a second pair of grooves 7B from the aforementioned plurality of grooves 7A. Specifically, the plurality of blocks 8 is formed on each of the shoulder zones 6 of the tread band 2, as well as on the intermediate zones 5 and the central zone C of the tread band 2. The combination of the blocks 8 and the plurality of grooves 7A, 7B described above defines the tread pattern of the tyre 1.

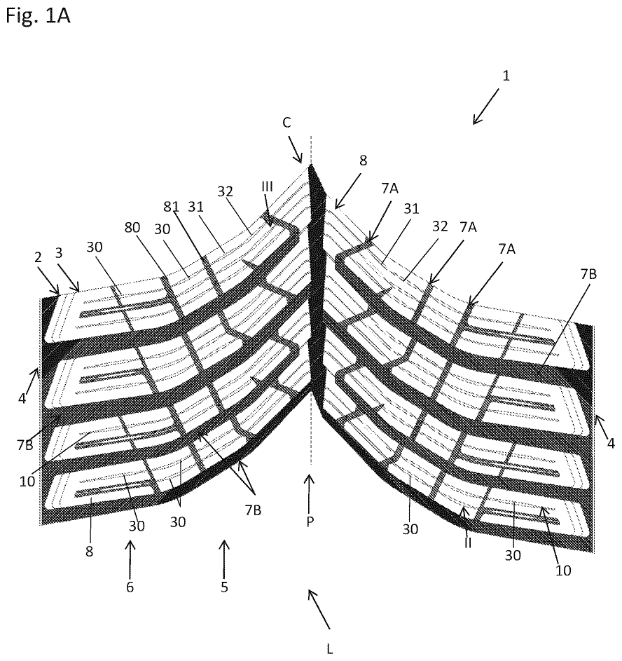

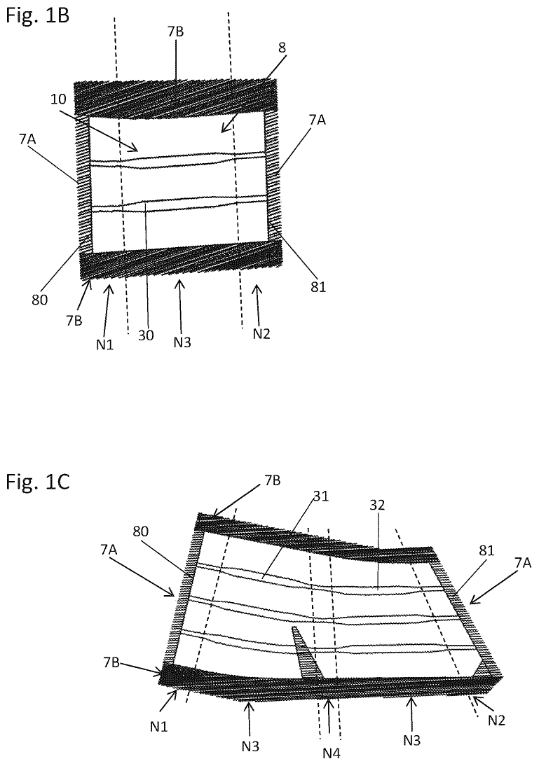

On the plurality of blocks 8, a plurality of sipes 10 is formed, extending transversely across the said plurality of blocks 8. Advantageously, this plurality of sipes 10 has a sipe width denoted as W and is open on the tread surface 3. As clearly visible in FIGS. 1B and 1C, each sipe 10 from the plurality of sipes 10 extends from a first zone of the block 8, indicated by reference N1, located at the aforementioned first edge 80 of the block 8, to a second zone of the block 8, indicated by reference N2, positioned at the aforementioned second edge 81 of the block 8.

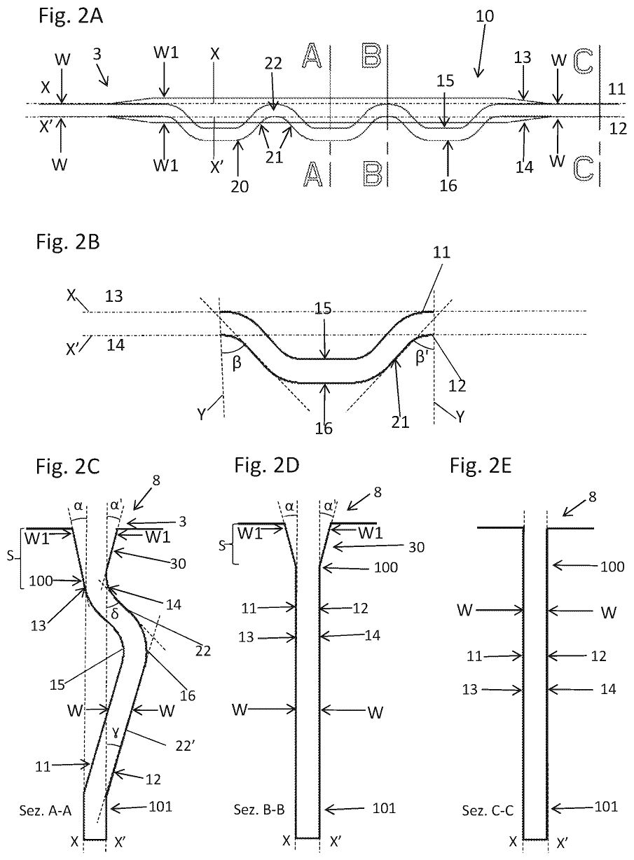

Advantageously, in the first zone N1 and the second zone N2, the sipe 10 has a sipe width denoted as W, as shown in FIG. 2E corresponding to the section C-C of FIG. 2A. In further embodiments, each plurality of sipes 10 is substantially parallel to a respective second pair of grooves 7B.

Advantageously, as depicted in FIG. 1A, a block 8 includes a first and a second sipe 10 from the plurality of sipes 10, substantially parallel to each other. Preferably, the first and second sipes 10 are longitudinally spaced apart by a distance greater than 3 mm and less than 6 mm, inclusive of the endpoints.

More preferably, the first and second sipes 10 are longitudinally spaced apart by a distance ranging from 3.2 mm to 4.6 mm, inclusive of the endpoints. Each sipe 10, as clearly visible in FIGS. 2A-2E, separates the respective block 8 into a first and a second block portion, denoted by reference numbers 11 and 12, respectively. In more detail, the first and second block portions 11, 12 each have a first surface 13 and a second surface 14 facing the first surface 13.

For clarity, as shown, for example, in FIG. 2C, the first surface 13 extends along a first reference plane denoted as X, which plane is incident to the tread surface 3.

Similarly, the second surface 14 extends along a second reference plane X′, which is also incident to the tread surface 3.

Advantageously, as visible in FIG. 1B, in a third zone N3 located between the first zone N1 and the second zone N2, at least one of the first surface 13 and the second surface 14 deviates from its respective reference plane X, X′ toward the tread surface 3, creating at least one chamfer 30.

Furthermore, in an advantageous manner, the chamfer 30 can be formed by both the first surface 13 and the second surface 14, both deviating from their respective reference planes X, X′.

Alternatively, the chamfer 30 can be formed solely by the first surface 13, deviating from its respective first reference plane X, or solely by the second surface 14, deviating from its respective second reference plane X′.

Preferably, the chamfer 30 extends across the block 8 in the transverse direction, covering more than 35% and less than 95% of the lateral extent of the block 8.

More specifically, the transverse extension of the chamfer 30 on the block 8 is preferably less than or equal to 80% of the lateral extent of the block 8, and even more preferably, less than or equal to 70% of the lateral extent of the block 8.

Advantageously, the chamfer 30 is formed in the blocks 8 defined in the shoulder zones 6.

Additionally, the chamfer 30 can also be formed in the blocks 8 defined in the intermediate zones 5.

More preferably, said chamfer 30 is formed in correspondence with blocks 8 defined both in said shoulder zones 6 and in said intermediate zones 5.

Even more preferably, said chamfer is also formed in correspondence with blocks defined in the central zone C of said tyre.

Alternatively, on said central zone C of said tread band 2 are provided, preferably, blocks 8 equipped only with simple type sipes.

Even more preferably, said chamfer 30 has an extension on said block 8 in a transverse direction greater than or equal to 10 mm.

Preferably, the extension in the transverse direction of said chamfer 30 on said block 8 is less than or equal to 30 mm.

Preferably, the extension in the transverse direction of said chamfer 30 on said block 8 is between 10 mm and 30 mm, extremes included.

Preferably, the extension in the transverse direction of said chamfer 30 on said block 8 in the shoulder zones 6 is greater than 13 mm and less than 26 mm, extremes included.

Always preferably, the extension in the transverse direction of said chamfer 30 on said block 8 in the intermediate zones 5 is greater than 11 mm and less than 21 mm, extremes included.

Advantageously, with reference to FIGS. 2C and 2D, relating to the cross sections A-A and B-B of FIG. 2A, the chamfer 30 has, in correspondence with the tread surface, a chamfer width W1.

Advantageously, the chamfer width W1 is larger than the sipe width W. Preferably, chamfer width W1 is greater than the sipe width W by an amount greater than 30% and less than 150% of the sipe width W.

Preferably said chamfer width W1 is double said sipe width W. Advantageously, referring to the B-B section of FIG. 2A, visible in detail in FIG. 2D, it is noted how the chamfer width W1 is greater than the sipe width W.

This is more visible when comparing the B-B section (FIG. 2D) of the sipe 10, made in correspondence with the chamfer 30 having the aforementioned chamfer width W1, with the C-C section (FIG. 2E) of the sipe 10, made in correspondence with the second zone N2 of block in which the sipe 10 has the aforementioned sipe width W.

As previously stated, advantageously, said chamfer 30 creates a substantially “funnel” or “pocket” shape/structure that serves as an invitation for the snow that, during the rolling of the tyre 1, inserts itself inside it, getting stuck.

Referring to FIGS. 2A-2D, in correspondence with the chamfer 30, the first surface 13 is inclined with respect to the relative first reference plane X to realize the chamfer 30 of a first angle α.

Still referring to the same figures, in correspondence with the chamfer 30 the second surface 14 is inclined with respect to the relative second reference plane X′ of a second angle α′.

In preferred embodiments, the second angle α′ is greater than the first angle α. Preferably, the first angle α and/or the second angle α′ are/is between about 5° and about 50°.

More preferably, said first angle α and/or said second angle α′, are/is between about 10°and about 15°.

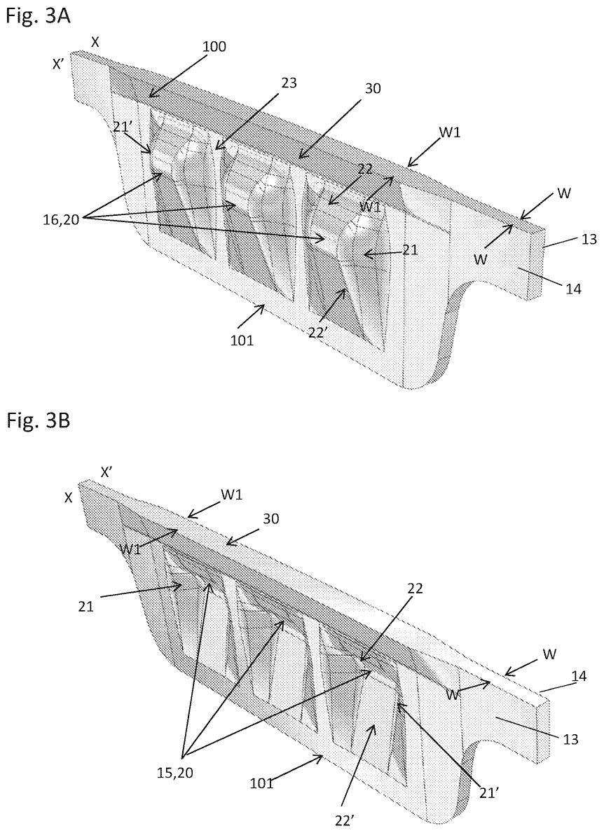

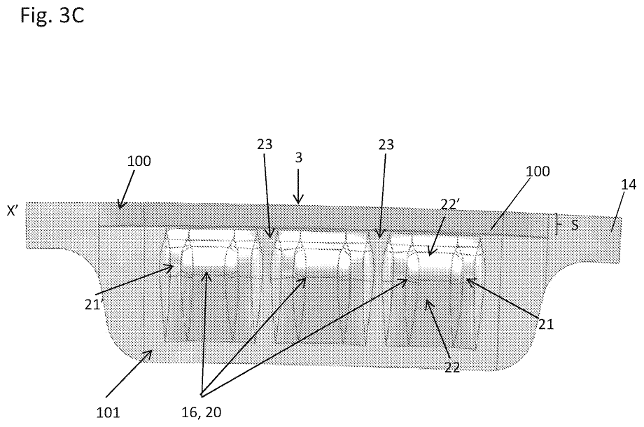

Advantageously, as visible in FIGS. 2A-2D and 3A-3C the chamfer 30 has a radial dimension S.

This radial dimension goes, advantageously, from a top portion 100 of said sipe 10 to the tread surface 3.

In more detail, the top portion 100 is a portion of the sipe 10 that is positioned radially outside with respect to a base 101 of the sipe 10.

Advantageously, the base 101 and the top portion 100 of the sipe 10 lie on the respective reference plane X, X′ in such a way as to be substantially in axis with each other.

In preferred embodiments, the aforementioned radial dimension S of the chamfer 30 is greater than 1 mm and less than 2 mm.

As visible in FIGS. 1A, 1C, in a further embodiment, the block 8 includes a fourth zone N4 is included between the first zone N1 and the second zone N2.

Advantageously, in the aforementioned fourth zone N4 the sipe 10 has the sipe width W, as defined above.

In particular, at least one of said first surface 13 and said second surface 14 moves away from the respective reference plane X, X′ up to said tread surface 3, realizing a first chamfer 31 and a second chamfer 32.

Advantageously, said first chamfer 31 and said second chamfer 32 are arranged in two respective third zones N3 separated from each other by said fourth zone N4. Said first and said second chamfer 31, 32 have said chamfer width W1 in correspondence with said tread surface 3.

Advantageously, the first and second chamfer 31, 32 have the aforementioned chamfer width W1 in correspondence with the tread surface 3.

In preferred embodiments, the block 8 includes the fourth zone N4 when its lateral extension is greater than 30 mm and less than 60 mm.

Again, advantageously, the first chamfer 31 and the second chamfer 32 have an extension greater than 35% and less than 60% of the lateral extension of the block 8.

Even more preferably, said first chamfer 31 and said second chamfer 32 have, respectively, an extension less than or equal to 40% of the lateral extension of the block 8.

In particular, the sum of the extension of the first chamfer 31 and the second chamfer 32 is less than 95% of the lateral extension of said block 8.

Advantageously, the presence of the fourth zone N4 ensures that the amount of snow that can get stuck inside the sipe 10 is kept high, reducing the possibility of having a very extended chamfer 30.

In a further embodiment, as visible for example in some blocks of FIG. 1A, preferably in the shoulder zones 6, despite the lateral extension of the block 8 being greater than 30 mm and less than 60 mm, said block only presents a first zone N1 and a second zone N2 between which there is a single chamfer 30.

Again, preferably the sipes 10 are of simple and/or three-dimensional type. Advantageously, in the case shown in FIG. 2A, 2B-2C and 3A-3C, where the sipes are of the three-dimensional type, the first surface 13 includes at least one protrusion 15 extended from the reference plane X towards the second portion of block 12, while the second surface 14 includes at least one corresponding recess 16 extended from the respective reference plane X′ away from the first portion 11 of block 8 and shaped in such a way as to at least partially couple with the protrusion 15, thus forming at least one respective male-female coupling.

Preferably, as more visible in FIGS. 3A and 3B all the male-female couplings provided between the first portion 11 of block 8 and the second portion 12 of block 8 are formed by protrusions 15 obtained on the first surface 13 and by corresponding recesses 16 obtained on the second surface 14.

In a more preferred way, as visible in FIG. 3A, all the protrusions 15 of the sipe 10 are obtained on the first surface 13, so that the second surface 14 is devoid of protrusions, and in an equally preferred way, as visible in FIG. 3B, all the recesses 16 are obtained on the second surface 14, so that the first surface 13 is devoid of recesses.

According to the embodiment under examination, the tyre 1 is of the directional type when the first surface 13 does not include recesses 16 and the second surface 14 does not include protrusions 15.

In the preferred and illustrated embodiment, the protrusions 15 and the recesses 16 are obtained, respectively, on the first surface 13 and on the second surface 14 at a radially internal level with respect to the tread surface 3.

Advantageously, referring to the A-A section of FIG. 2A, visible in detail in FIG. 2C, several factors are denoted; as previously stated, it is denoted that the chamfer width W1 is greater than the sipe width W; the presence of the protrusions 15 on the second surface 14 of the block 8 and of the recesses 16 in correspondence with the first surface 13 of the block 8 is denoted; as well as the fact that the protrusions 15 and the recesses 16 are obtained on the respective surface 13, 14 at a radially internal level with respect to the tread surface 3.

Preferably, the aforementioned level is not higher than 45% of the depth of the sipe 10, preferably not higher than 30%.

More preferably, said level, as previously described, is greater than 2 mm and less than 3 mm.

It is understood that the recesses 16 obtained on the second surface 14 have a conformation analogous and corresponding to the protrusions 15.

Based on what has just been said, for descriptive simplicity, what will be described in relation to the protrusions 15 is to be considered valid and analogous for the description of the recesses 16.

In a preferred, but not limiting, embodiment, for each three-dimensional type sipe 10, at least three protrusions 15 are provided.

In a preferred embodiment, each sipe 10 has five protrusions 15. Thanks to this feature, the increased effectiveness of the performance at the level of a single protrusion 15 is significantly multiplied and extended over a larger longitudinal dimension, typically over the entire longitudinal extension of the sipe 10.

Advantageously, at least one of said protrusions 15 includes, in the portion of maximum protrusion, a respective edge 20 that extends substantially parallel to the first reference plane X.

Advantageously, each edge 20, as just described, makes it structurally more effective the aforementioned “pocket” effect, favoring the function of snow interlocking inside the sipe 10. As visible in FIGS. 2A-2E and 3A-3C, the aforementioned edge 20 is radially positioned between the base 101 and the top portion 100 of the sipe 10.

Furthermore, the edge 20 is distanced from the reference plane X by a measure not exceeding 30% of the depth of the sipe 10 measured in correspondence with the edge 20. Preferably, it is distanced from the reference plane X by a measure equal to about 20% of such depth.

The protrusions 15 are substantially identical to each other.

In more detail, preferably said at least one protrusion 15 has a substantially prismatic conformation with a quadrilateral plan. Referring to FIGS. 2C and 3A-3C, in this conformation, advantageously, said edge 20 is connected to the first reference plane X through lateral connection surfaces, indicated with the numerical references 21 and 21′, as well as through radial connection surfaces, indicated with the numerical references 22 and 22′.

The aforementioned connection surfaces are substantially flat. Advantageously, the radial connection surfaces 22, 22′ are arranged, respectively, radially above and radially below with respect to the edge 20.

In greater detail, a first radial connection surface 22′, of the aforementioned connection surfaces 22, 22′, connects to the first reference plane X radially below with respect to the edge 20 at a respective level radially above with respect to the base 101 of the sipe 10.

Instead, a second radial connection surface 22, of the aforementioned connection surfaces 22, 22′, connects to the first reference plane X radially above with respect to the edge 20 at a respective level radially below with respect to at least one chamfer 30.

In more detail, the radial connection surfaces 22, 22′ are inclined radially above by a fifth angle δ that goes from the edge 20 to the reference plane X and radially below by a sixth angle γ that goes from the edge 20 to the reference plane X.

Advantageously, in a preferred way said sixth angle γ is less than said fifth angle δ.

In more detail, in a preferred way, said fifth angle δ is less than 50°. Preferably, said fifth angle δ is greater than 40°.

More preferably, said fifth angle δ is between 40° and 50°, extremes included. For example, said fifth angle δ is 45°.

Advantageously, the amplitude of the aforementioned fifth angle δ can depend on the depth of said sipe 10.

With respect to said sixth angle γ, in a preferred way it is less than 35°. Preferably, said sixth angle γ is greater than 10°.

More preferably, said sixth angle y is between 10° and 35°, extremes included. For example, said sixth angle y is 16°.

Advantageously, the amplitude of the aforementioned sixth angle γ depends on the depth of said sipe 10.

In more detail, the greater the depth of the sipe 10, the greater will be the amplitude of the aforementioned sixth angle γ, as seen in the following examples.

Just as an example, when said sipe 10 has a depth of 5 mm, said sixth angle γ is preferably 10°.

Again as an example, when said sipe 10 has a depth of 7 mm, said sixth angle γ is preferably 16°.

Another example is that when said sipe 10 has a depth of 9 mm, said sixth angle γ is preferably 35°.

The lateral connection surfaces 21, 21′ are located in correspondence with two opposite sides of the edge 20.

In more detail, the aforementioned lateral connection surfaces 21, 21′ are inclined, respectively, from the edge 20 to the first reference plane X by a third angle β and a fourth angle β′, with respect to a third plane Y perpendicular to the first reference plane X.

Preferably, said third angle β and said fourth angle β′ are substantially equal.

In more detail, preferably, said third angle β and/or said fourth angle β′ are less than 55°.

Preferably, said third angle β and/or said fourth angle β′ are greater than 35°. More preferably, said third angle β and/or said fourth angle β′ are between 35° and 55°, extremes included.

For example, said third angle β and/or said fourth angle β′ are 45°.

In the embodiment under examination, the lateral connection surfaces 21, 21′ of two edges 20 related to protrusions 15 adjacent to each other realize a connected portion 23, lying on the first reference plane X and having an extension in the direction parallel to the first reference plane X smaller than the extension of at least one of the two edges 20.

Advantageously, the alternation between connected portions 23 and edges 20 creates a substantially zigzag structure in the depth of each sipe such that a differentiated deformability of the block portions is obtained, avoiding strong deformations.

In particular, without wanting to be bound by any interpretative theory, this structure ensures that the tangential stresses exerted on the block during braking lead to an improvement in the mutual locking of the block portions; at the same time, during traction, this structure allows the sipe to open more.

Furthermore, advantageously, this structure can also increase the effectiveness of the aforementioned “pocket” effect, favoring the function of snow interlocking inside it.

Advantageously, the extension of the edge 20 is greater than 2 mm and less than 5 mm.

The extension of the connected portion 23 is greater than 0.5 mm and less than 3 mm.

Finally, in a further embodiment, not shown in the figures, the tyre 1 is of the asymmetric type in the case where the first surface 13 includes recesses 16 and the second surface 14 includes protrusions 15.

The invention as conceived and illustrated here is susceptible to numerous modifications and variations, all falling within the scope of the inventive concept.

Furthermore, all details can be replaced by other technically equivalent elements.

Where the characteristics and techniques mentioned in any claim are followed by reference signs, these reference signs have been attached for the sole purpose of increasing the intelligibility of the claims and, consequently, such reference signs have no limiting effect on the interpretation of each element identified by way of example by such reference signs.

1-34. (canceled)

35. A tire comprising a tread band on which, in a radially external position to the tire, a tread surface is defined,
wherein the tread band comprises:
a plurality of grooves;
a plurality of tread blocks delimited by at least a first pair of grooves of the plurality of grooves, wherein the first pair of grooves defines on the tread block a first edge and a second edge of tread block;
a plurality of sipes, extending transversely on the plurality of blocks, the sipes having a sipe width (W) and open on the tread surface, wherein, each sipe of the plurality of sipes extending from a first zone (NI) of the block placed at the first edge, to a second zone (N2) of the block placed at the second edge, and wherein in the first and second zones (NI, N2), the sipe having the sipe width,
the sipe separating the block into a first portion comprising a first surface, extending along a first reference plane (X) incident to the tread surface, and into a second portion comprising a second surface, extending along a second reference plane (X') incident to the tread surface,
wherein, in a third zone (N3) located between the first zone (NI) and the second zone (N2), at least one of the first surface and the second surface extends away from the respective reference plane (X, X′) to the tread surface, making at least one chamfer having, at the tread surface, a chamfer width (WI) of a dimension greater than the sipe width (W).

36. The tire according to claim 35, wherein in connection with the chamfer, the first surface, the second surface, or both are inclined from opposing sides with respect to the respective reference plane (X, X') by a respective first angle (a), a respective second angle (a′), or both.

37. The tire according to claim 36, wherein the second angle (a′) is greater than the first angle (a).

38. The tire according to claim 36, wherein the first angle (a), the second angle (a'), or both range from about 5° to about 50°.

39. The tire according to claim 35, wherein the at least one chamfer has a radial dimension(S) extending from a top portion of the sipe to the tread surface, wherein the top portion is placed radially outward from a base of the sipe.

40. The tire according to claim 35, wherein the radial dimension(S) ranges from greater than 1 mm to less than 2 mm.

41. The tire according to claim 35, wherein the chamfer has an extension on the block, in transverse direction, ranging from greater than 35% to less than 95% of a lateral extension of the block.

42. The tire according to claim 42, wherein the block comprises a fourth zone (N4) disposed between the first zone (N1) and the second zone (N2) and wherein the sipe has the sipe width (W),
wherein the at least one between the first surface and the second surface moves away from the respective reference plane (X, X′) to the tread surface, making a first chamfer and a second chamfer,
wherein the first chamfer and the second chamfer are arranged in two respective third zones (N3) separated from each other by the fourth zone (N4), and
wherein the first and the second chamfer have the chamfer width (W1) in association with the tread surface.

43. The tire according to claim 42, wherein the block comprises the fourth zone (N4) when the lateral extension of the block ranges from greater than 30 mm to less than 60 mm.

44. The tire according to claim 35, wherein the first chamfer and the second chamfer have an extension greater than 35% and less than 60% of the lateral extension of the block, and wherein the sum of the extension of the first chamfer and the second chamfer is less than 95% of the lateral extension of the block.

45. The tire according to claim 35, wherein the chamfer width (W1) is greater than the sipe width (W) by an amount ranging from greater than 30% to less than 150% of the sipe width (W).

46. The tire according to claim 35, wherein the plurality of blocks is delimited by a second pair of grooves of the plurality of grooves, and wherein each of the plurality of sipes is substantially parallel to a respective second pair of grooves.

47. The tire according to claim 35, wherein the block comprises at least a first sipe and a second sipe substantially parallel to each other.

48. The tire according to claim 47, wherein the first and second sipes are spaced longitudinally with each other by a distance ranging from greater than 3 mm to less than 6 mm.

49. The tire according to claim 35, wherein the plurality of sipes is of the three-dimensional type.

50. The tire according to claim 35, wherein between the first portion and the second portion of the block is provided a plurality of male-female couplings comprising:
at least one protuberance formed on the first surface and extending from the first reference plane (X) toward the second portion of the block, and
at least one recess formed on the second surface and extending from the second reference plane (X′) away from the first portion of block, wherein the at least one protuberance is placed, in a portion of maximum protuberance, at a height radially inward from the tread surface.

51. The tire according to claim 50, wherein the height is no more than 45% of the depth of the sipe.

52. The tire according to claims 50, wherein the height ranges from greater than 2 mm to less than 3 mm.

53. The tire according to claim 50, wherein the at least one protuberance comprises, in the portion of maximum protuberance, a respective block edge extending substantially parallel to the first reference plane (X).

54. The tire according to claim 39, wherein the block edge is placed radially between the base and the top portion of the sipe.

55. The tire according to claim 39, wherein the base and the top portion of the sipe lie on the respective reference plane (X, X′).

56. The tire according to claim 50, wherein the at least one protuberance comprises a conformation substantially prismatic with quadrilateral base and the block edge is connected to the first reference plane (X) by substantially flat lateral and radial connecting surfaces.

57. The tire according to claim 56, wherein the radial connecting surfaces are arranged radially above and below the block edge.

58. The tire according to claim 56, wherein the lateral connecting surfaces are placed at two opposite sides of the block edge.

59. The tire according to claim 56, wherein the lateral connecting surfaces are inclined, respectively, from the block edge to the first reference plane (X), by a third and a fourth angle (p, p′) with respect to a third plane (Y) perpendicular to the first reference plane (X).

60. The tire according to claim 59, wherein the third angle, the fourth angle or both (p, p′) range from between about 35° to about 55°.

61. The tire according to claim 56, wherein the radial connecting surfaces are inclined radially upwardly from the block edge to the first reference plane (X) by a fifth angle (5) and radially downwardly from the block edge to the first reference plane (X) by a sixth angle (y).

62. The tire according to claim 61, wherein the fifth angle ranges from between about 40° to about 50°.

63. The tire according to claim 61, wherein the sixth angle (y) ranges from between about 10° to about 35°.

64. The tire according to claim 56, wherein a first radial connecting surface connects to the first reference plane (X) radially downwardly with respect to the block edge at a respective height radially upward with respect to the base of the sipe.

65. The tire according to claim 56, wherein a second radial connecting surface connects to the first reference plane (X) radially upwardly with respect to the block edge at a respective height radially downward with respect to the at least one chamfer.

66. The tire according to claim 50, wherein the lateral connecting surfaces of two block edges of protuberances adjacent to each other form a connected portion, lying on the first reference plane (X) and having an extension in a direction parallel to the reference plane (X) smaller than the extension of at least one of the two block edges.

67. The tire according to claim 66, wherein the extension of the block edge ranges from greater than 2 mm to less than 5 mm and the extension of the connected portion ranges from greater than 0.5 mm to less than 3 mm.

68. The tire according to claim 50, wherein the tire is of the directional type, the first surface does not include recesses and the second surface does not include protuberances.
